(19) United States
(12) Patent Application Publication
(10) Pub. No.: US 2012/0079255 A1
(43) Pub. Date: Mar. 29, 2012

(54) INDIRECT BRANCH PREDICTION BASED ON BRANCH TARGET BUFFER HYSTERESIS

(76) Inventors: Jonathan D. Combs, Austin, TX (US); Kulin N. Kothari, Austin, TX (US)

(21) Appl. No.: 12/890,651

(22) Filed: Sep. 25, 2010

(51) Int. Cl. G06F 9/38

(52) U.S. Cl. 712/239; 712/E09.045

(57) ABSTRACT

Methods and apparatus to perform efficient indirect branch prediction operations are described. In one embodiment, a branch target buffer (BTB) stored a target address and a bimodal hysteresis counter for an indirect branch that has been encountered by a front-end of the processor during a time period. An indirect branch prediction logic then generates a prediction for an instruction corresponding to a indirect branch based on the stored bimodal hysteresis counter of the BTB. Other embodiments are also claimed and disclosed.

### FIELD

The present disclosure generally relates to the field of electronics. More particularly, an embodiment of the invention relates to techniques for an indirect branch prediction based on Branch Target Buffer (BTB) hysteresis.

### BACKGROUND

To improve performance, some processors may utilize branch prediction. For example, when a computer processor encounters an instruction with a branch, branch prediction may be used to predict whether the branch will be taken and cause retrieval of the predicted instruction rather than waiting for the current instruction to be executed. As a result, branch prediction may eliminate the need to wait for the outcome of branch instructions and therefore keep the processor pipeline as full as possible. For these reasons, branch prediction may be a significant contributor to processor performance.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 4, and 5 illustrate block diagrams of embodiments of computing systems, which may be utilized to implement various embodiments discussed herein.

FIG. 2 illustrates a block diagram of portions of a processor core and other components of a computing system, according to an embodiment.

FIG. 3 illustrates a flow diagram of a method in accordance with an embodiment.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof. Also, the use of “instruction” and “micro-operation” (uop) is interchangeable as discussed herein.

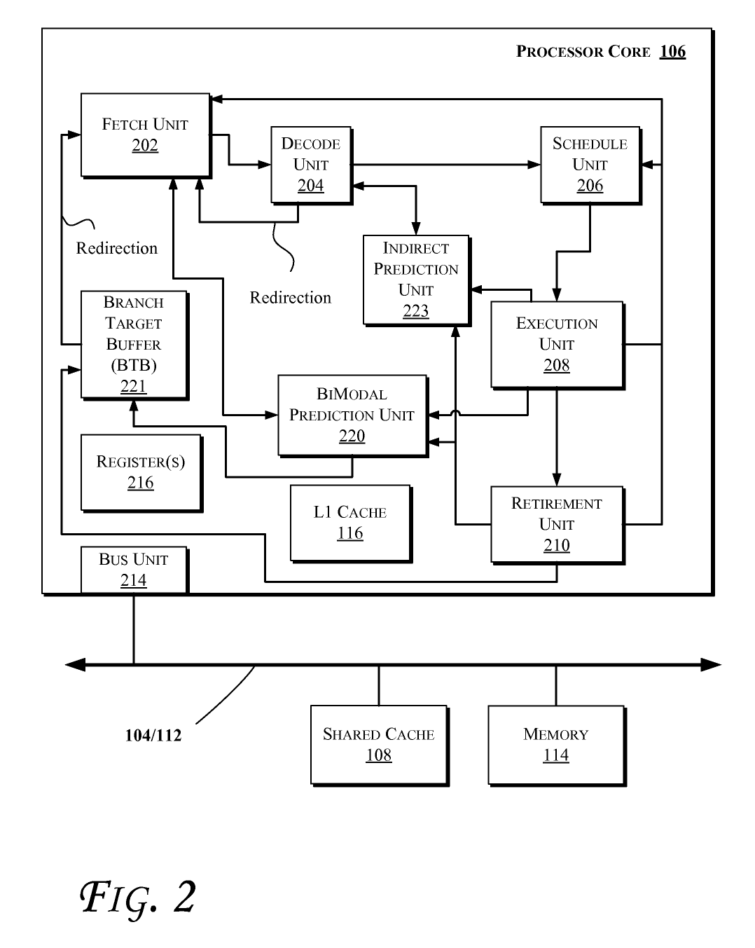

Some of the embodiments discussed herein may be utilized to perform efficient indirect branch prediction in a processor. Indirect branches are one type of branching that have increasingly become more important (e.g., in object-oriented programs). However, successfully predicting indirect branches is difficult as branch targets are generally loaded from a register (instead of being immediately available targets). To address some of these issues, history data (e.g., stored in a Branch Target Buffer (BTB)) may be used by an indirect branch predictor to assist in predicting indirect branches. For example, BTB may store a probable target address for each indirect branch that the front-end of a processor encounters. Also, in one embodiment, the “hysteresis” or “history data” discussed herein may correspond to one or more “bimodal” counters, and not the BTB itself. For example, the bimodal data may be stored into the BTB. If the counter(s) are separate (e.g., as discussed with reference to FIG. 2), the hysteresis information may be obtained from the bimodal (or whatever form of “local history” based prediction is in place).

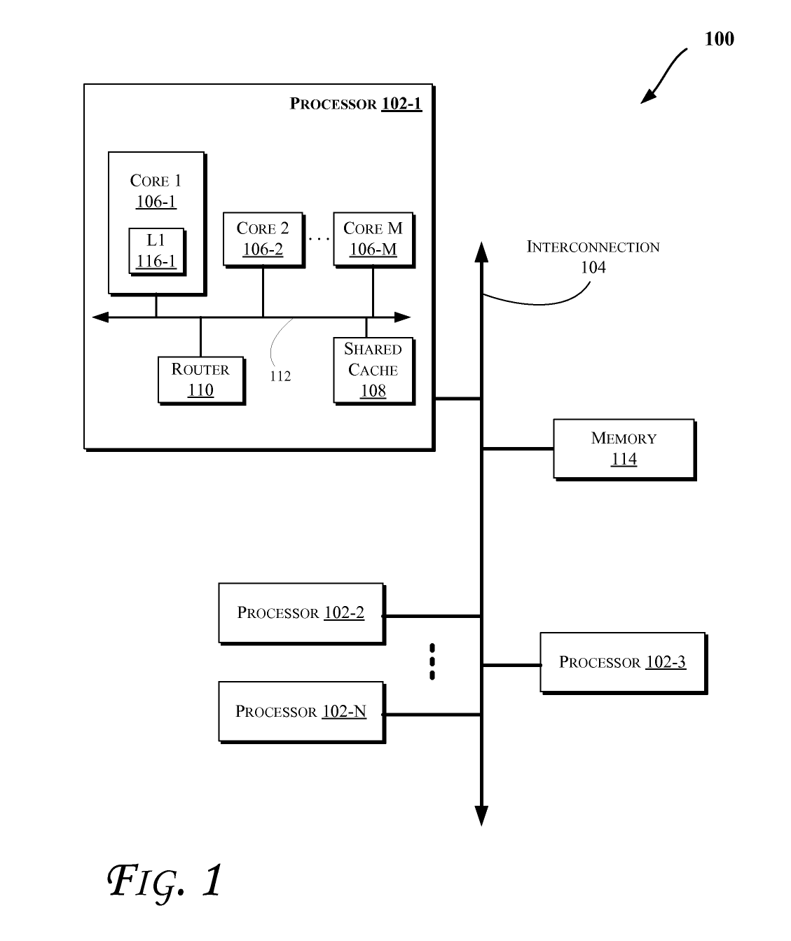

The techniques discussed herein may be used in a prediction component of a processor, such as the processors discussed with reference to FIGS. 1 and 4-5. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection network or bus 104. Each processor may include various components some of which are only discussed with reference to processor 102-1 for clarity. Accordingly, each of the remaining processors 102-2 through 102-N may include the same or similar components discussed with reference to the processor 102-1.

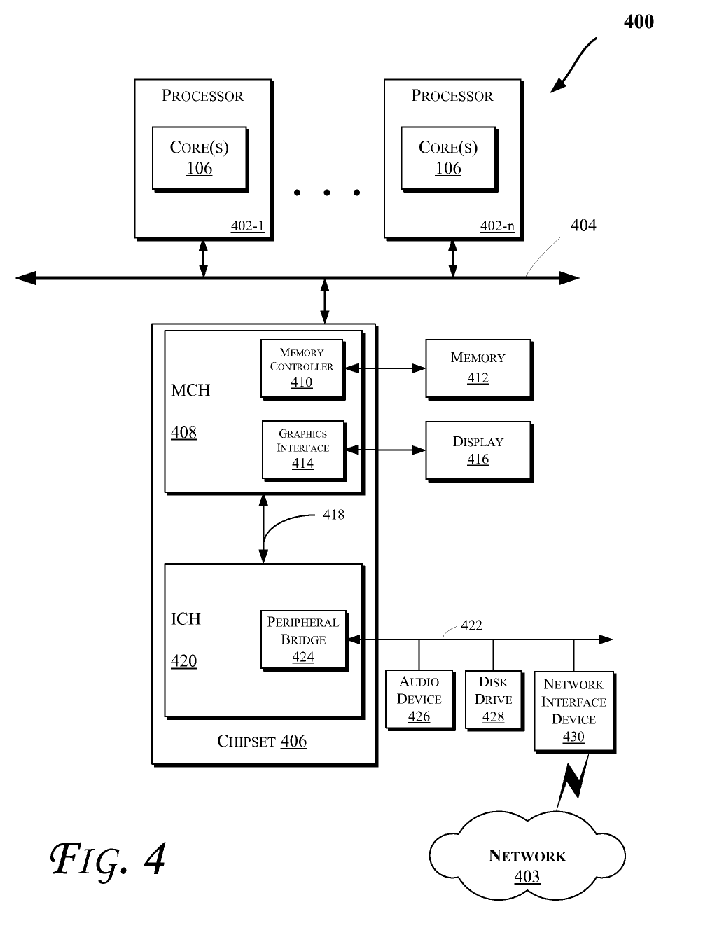

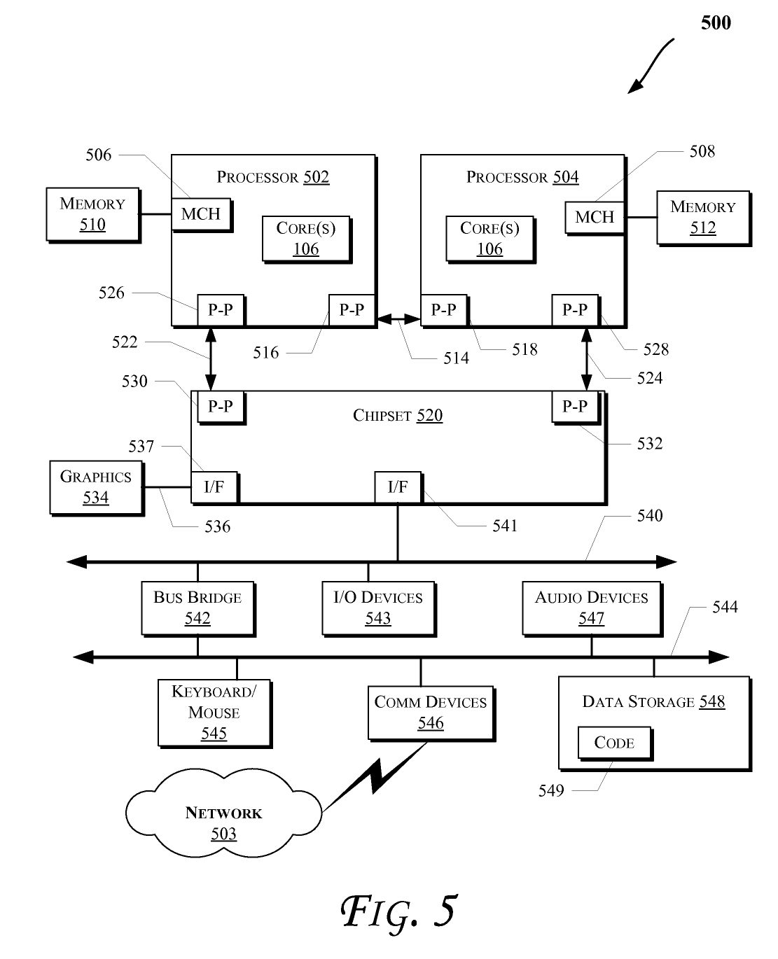

In an embodiment, the processor 102-1 may include one or more processor cores 106-1 through 106-M (referred to herein as “cores 106” or more generally as “core 106”), a shared cache 108, and/or a router 110. The processor cores 106 may be implemented on a single integrated circuit (IC) chip. Moreover, the chip may include one or more shared and/or private caches (such as cache 108), buses or interconnections (such as a bus or interconnection network 112), memory controllers (such as those discussed with reference to FIGS. 4 and 5), or other components.

In one embodiment, the router 110 may be used to communicate between various components of the processor 102-1 and/or system 100. Moreover, the processor 102-1 may include more than one router 110. Furthermore, the multitude of routers (110) may be in communication to enable data routing between various components inside or outside of the processor 102-1.

The shared cache 108 may store data (e.g., including instructions) that are utilized by one or more components of the processor 102-1, such as the cores 106. For example, the shared cache 108 may locally cache data stored in a memory 114 for faster access by components of the processor 102. In an embodiment, the cache 108 may include a mid-level cache (such as a level 2 (L2), a level 3 (L3), a level 4 (L4), or other levels of cache), a last level cache (LLC), and/or combinations thereof. Moreover, various components of the processor 102-1 may communicate with the shared cache 108 directly, through a bus (e.g., the bus 112), and/or a memory controller or hub. As shown in FIG. 1, in some embodiments, one or more of the cores 106 may include a level 1 (L1) cache (116-1) (generally referred to herein as “L1 cache 116”).

FIG. 2 illustrates a block diagram of portions of a processor core 106 and other components of a computing system, according to an embodiment of the invention. In one embodiment, the arrows shown in FIG. 2 illustrate the flow direction of instructions through the core 106. One or more processor cores (such as the processor core 106) may be implemented on a single integrated circuit chip (or die) such as discussed with reference to FIG. 1. Moreover, the chip may include one or more shared and/or private caches (e.g., cache 108 of FIG. 1), interconnections (e.g., interconnections 104 and/or 112 of FIG. 1), memory controllers, or other components.

As illustrated in FIG. 2, the processor core 106 may include a fetch unit 202 to fetch instructions (including instructions with conditional or indirect (e.g., unconditional) branches) for execution by the core 106. The instructions may be fetched from any storage devices such as the memory 114 and/or the memory devices discussed with reference to FIGS. 4 and 5. The core 106 may also include a decode unit 204 to decode the fetched instruction. For instance, the decode unit 204 may decode the fetched instruction into a plurality of uops (micro-operations). Additionally, the core 106 may include a schedule unit 206. The schedule unit 206 may perform various operations associated with storing decoded instructions (e.g., received from the decode unit 204) until the instructions are ready for dispatch, e.g., until all source values of a decoded instruction become available. In one embodiment, the schedule unit 206 may schedule and/or issue (or dispatch) decoded instructions to an execution unit 208 for execution. The execution unit 208 may execute the dispatched instructions after they are decoded (e.g., by the decode unit 204) and dispatched (e.g., by the schedule unit 206).

In an embodiment, the execution unit 208 may include more than one execution unit, such as a jump execution unit (JEU). In one embodiment, a branch may be resolved at execution (e.g., by a component of the jump execution unit) and used to update and/or allocate branches in a bimodal predictor unit 220 to more accurately predict future branches. In some embodiments, the core 106 may also utilize a little (or small) global predictor (g), a big (or large) global predictor (G), and/or a loop predictor (L). The execution unit 208 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 208.

Further, the execution unit 208 may execute instructions out-of-order. Hence, the processor core 106 may be an out-of-order processor core in one embodiment. The core 106 may also include a retirement unit 210. The retirement unit 210 may retire executed instructions after they are committed. In an embodiment, retirement of the executed instructions may result in processor state being committed from the execution of the instructions, physical registers used by the instructions being de-allocated, etc.

The core 106 may also include a bus unit 214 to enable communication between components of the processor core 106 and other components (such as the components discussed with reference to FIG. 1) via one or more buses (e.g., buses 104 and/or 112). The core 106 may also include one or more registers 216 to store data accessed by various components of the core 106 (such as branch targets for indirect branches).

As illustrated in FIG. 2, the core 106 may include the bimodal branch prediction unit/logic 220 to generate a prediction regarding an instruction with a conditional or unconditional branch that is fetched from a storage unit such as the cache 108, cache 116, and/or memory 114. The core 106 may also include a BTB 221 to store a probable target address for each indirect taken branch that the front-end of a processor (e.g., fetch/decode units 202 and 204) encounters during a time period (e.g., due to size limitations of the BTB, some entries (e.g., older entries) may be replace with other entries (e.g., newer ones)) and an indirect prediction unit/logic 223 (which may be interchangeably referred to herein as “indirect predictor”) to generate a prediction regarding an instruction with a indirect branch that is fetched from a storage unit such as the cache 108, cache 116, and/or memory 114. The BTB 221 may be any type of a storage unit such as those discussed with reference to memory 412 of FIG. 4. In an embodiment, BTB 221 and fetch unit 202 may be accessed in parallel.

In an embodiment, the prediction units 220 and 223 may predict whether a branch corresponding to a current instruction will be taken and cause retrieval of the predicted instruction (e.g., by the fetch unit 202 and/or decode unit 204), rather than having the processor core 106 wait for the current instruction to be executed or execute down the wrong sequential path.

Moreover, when branch prediction is spread out across a processor pipeline (e.g., as shown in FIG. 2), e.g., with different penalties at each point, the predictors at each point need a way to prioritize. For a shorter latency Branch Target Buffer (BTB) and a longer latency indirect predictor, prioritization would ideally be done after comparing whether the indirect prediction unit 223 predicts the same branch target as the BTB 221. In an embodiment, this prioritization problem is solved for the situation where a low penalty BTB and a higher latency indirect predictor needs to resolve this priority before waiting for the outcome of the target compare. Moreover, such embodiments reduce the power overhead of an indirect predictor for “last value” biased indirect branches.

For example, processors with smaller area and power budgets (such as mobile devices, laptop computer, netbooks, tablets, computing pads, etc.) cannot afford large BTBs (e.g., due to implementation/manufacturing costs, size constraints, power consumption restraints, etc.). These processors also may not add pipeline stages for the indirect predictor lookup as that may cost significant performance, power, and/or area. At the same time, the importance of predicting indirect branches correctly has increased, in part, due to higher usage of these branches by software and compilers. To this end, some embodiments may be used to overcome these issues and at the same time obtain the benefits of an indirect predictor.

In one embodiment, conditional branch hysteresis counters (e.g., provided in the BTB in an embodiment) are used to create an indirect chooser to remove the target compare off the critical path to redirection, while providing a way to power down the indirect predictor when it will not be useful. For example, in some processors, a BTB may hold branch targets for all taken branches, including indirect, conditional, and unconditional branches, and may contain a hysteresis counter (e.g., 2 bit counter; although more or less number of counter bits may be used in various embodiments) per entry (where each entry corresponds to a branch taken). While such a BTB may not handle the problem of changing indirect targets, it will predict the “last value” as seen from retirement. Some implementations may add a history based indirect predictor to solve the problem of changing targets. For example, history based branch prediction may be done at the end of the decode pipeline.

FIG. 2 represents a pipeline for the front end (e.g., including fetch and decode units 202 and 204) of a processor. As shown, prediction from the BTB 221 is done early in the fetch unit 202 pipeline and prediction from the indirect predictor 223 is done late in the decode unit 204 pipeline. Both the fetch and decode units may span multiple clock cycles in the pipeline. In some implementations, due to the array organization of the indirect predictor, the hit signal precedes the target by a significant margin. If the target prediction of the BTB is incorrect, a redirection may need to be transmitted to the fetch unit 202 to redirect the fetch unit to the new IP (Instruction Pointer). Generally, two types of redirection may be used, e.g., the redirection at the later point of the pipeline (from the decode unit 204 to the fetch unit 202) may be referred to as a branch address clear (baclear) and the redirection at the earlier point in the pipeline (from BTB 221 to the fetch unit 202) may be referred to as a “btclear”.

In order to determine if the BTB target is incorrect, a compare of the BTB and indirect predictor targets may be required. The result of this target compare could not resolve in time to hit the baclear pipeline. Hence, the decision to send a baclear must resolve solely based on getting an indirect predictor tag hit. As even last value biased indirect branches can become allocated into the indirect predictor under various scenarios, the resulting extended cycle bubble vs. 1 cycle bubble from the BTB would cause vulnerabilities in the predictions.

As indirect branches are unconditional and hence do not use the bimodal hysteresis counters in the BTB, an embodiment may utilize the bimodal hysteresis as a chooser. The target compare may now be done off the critical path. Mispredicting indirect branches may allocate a corresponding entry into both the BTB 221 and the indirect predictor 223, e.g., simultaneously. By allocating indirect branches into the BTB as “weakly” taken and incrementing to “strongly taken” if the indirect predictor hits and predicted the same target, the strongly taken state in the BTB becomes a cheap indirect chooser. In embodiment, the chosen state in the BTB may also be used to power down the indirect predictor 223, saving power for the many cases of single target indirect branches.

Moreover, this sort of mismatched pipeline would dictate that targets be compared before initiating the costly redirection through a baclear. This may be done but forces the tag compare followed by target compare onto the potentially critical path to redirection. An alternative solution of invalidating a same target matching indirect predictor entry prevents the indirect predictor from backing up the BTB in case the BTB entry gets replaced. With a “small” BTB on the low power cores, this replacement is non-negligible.

Also, even though the bimodal prediction unit 220 and BTB 221 are illustrated as separate modules in FIG. 2, these modules may be combined. In an embodiment, the combination may additionally include a TAC (Target Array Calculator) array, e.g., to obtain branch target, branch type, branch instruction location, and other information that may be needed to make predictions.

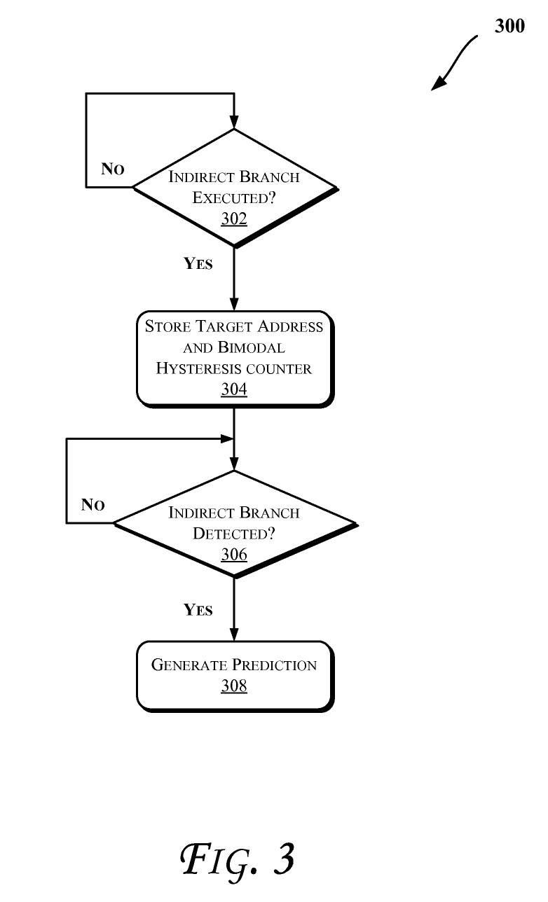

FIG. 3 illustrates a flow diagram of a method 300 to predict the outcome of an indirect branch instruction, according to an embodiment. In some embodiments, various components discussed with reference to FIGS. 1-2 and 4-5 may be utilized to perform one or more of the operations discussed with reference to FIG. 3. For example, one or more of the components of the BTB 221 and/or prediction unit(s) 220/223 of FIG. 2 may be used to perform at least some of the operations discussed with reference to FIG. 3.

Referring to FIGS. 1-3, at an operation 302, it is determined whether an indirect branch has executed and/or retired. At an operation 304, the target address and the bimodal hysteresis counter for the executed/retired indirect branch (that has been encountered by a front-end of a processor during a given time period and completed (e.g., as seen by the execution unit 208 and/or retirement unit 210)) may be stored in a branch target buffer (BTB) (such as BTB 221).

Once occurrence of a indirect branch is detected (e.g., at fetch unit 202 and/or decode unit 204) at operation 306, a prediction corresponding to the detected indirect branch may be made at operation 308, e.g., based on the stored bimodal hysteresis counter of the BTB corresponding to the detected indirect branch.

FIG. 4 illustrates a block diagram of a computing system 400 in accordance with an embodiment of the invention. The computing system 400 may include one or more central processing unit(s) (CPUs) 402 or processors that communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors. In an embodiment, one or more of the processors 402 may be the same or similar to the processors 102 of FIG. 1. For example, one or more of the processors 402 may include one or more of the cores 106 discusses with reference to FIGS. 1 and/or 2. Also, the operations discussed with reference to FIGS. 1-3 may be performed by one or more components of the system 400.

A chipset 406 may also communicate with the interconnection network 404. The chipset 406 may include a memory control hub (MCH) 408. The MCH 408 may include a memory controller 410 that communicates with a memory 412 (which may be the same or similar to the memory 114 of FIG. 1). The memory 412 may store data, including sequences of instructions, that may be executed by the CPU 402, or any other device included in the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The MCH 408 may also include a graphics interface 414 that communicates with a display device 416. In one embodiment of the invention, the graphics interface 414 may communicate with the display device 416 via an accelerated graphics port (AGP). In an embodiment of the invention, the display 416 (such as a flat panel display) may communicate with the graphics interface 414 through, for example, a signal converter that translates a digital representation of an image stored in a storage device such as video memory or system memory into display signals that are interpreted and displayed by the display 416. The display signals produced by the display device may pass through various control devices before being interpreted by and subsequently displayed on the display 416.

A hub interface 418 may allow the MCH 408 and an input/output control hub (ICH) 420 to communicate. The ICH 420 may provide an interface to I/O device(s) that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the CPU 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and a network interface device 430 (which is in communication with the computer network 403). Other devices may communicate via the bus 422. Also, various components (such as the network interface device 430) may communicate with the MCH 408 in some embodiments of the invention. In addition, the processor 402 and the MCH 408 may be combined to form a single chip. Furthermore, the graphics accelerator 416 may be included within the MCH 408 in other embodiments of the invention.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 5 illustrates a computing system 500 that is arranged in a point-to-point (PtP) configuration, according to an embodiment of the invention. In particular, FIG. 5 shows a system where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to enable communication with memories 510 and 512. The memories 510 and/or 512 may store various data such as those discussed with reference to the memory 412 of FIG. 4.

In an embodiment, the processors 502 and 504 may be one of the processors 402 discussed with reference to FIG. 4. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a graphics circuit 534 via a graphics interface 536, e.g., using a PtP interface circuit 537.

At least one embodiment of the invention may be provided within the processors 502 and 504. For example, one or more of the cores 106 of FIGS. 1-2 may be located within the processors 502 and 504. Other embodiments of the invention, however, may exist in other circuits, logic units, or devices within the system 500 of FIG. 5. Furthermore, other embodiments of the invention may be distributed throughout several circuits, logic units, or devices illustrated in FIG. 5.

The chipset 520 may communicate with a bus 540 using a PtP interface circuit 541. The bus 540 may communicate with one or more devices, such as a bus bridge 542 and I/O devices 543. Via a bus 544, the bus bridge 542 may communicate with other devices such as a keyboard/mouse 545, communication devices 546 (such as modems, network interface devices, or other communication devices that may communicate with the computer network 403), audio I/O device 547, and/or a data storage device 548. The data storage device 548 may store code 549 that may be executed by the processors 502 and/or 504.

In various embodiments of the invention, the operations discussed herein, e.g., with reference to FIGS. 1-5, may be implemented as hardware (e.g., logic circuitry), software, firmware, or combinations thereof, which may be provided as a computer program product, e.g., including (e.g., a non-transitory) machine-readable or computer-readable medium having stored thereon instructions (or software procedures) used to program a computer to perform a process discussed herein. The machine-readable medium may include a storage device such as those discussed with respect to FIGS. 1-5.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection).

Reference in the specification to “one embodiment,” “an embodiment,” or “some embodiments” means that a particular feature, structure, or characteristic described in connection with the embodiment(s) may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. A processor comprising:
a branch target buffer (BTB) to store a target address and a bimodal hysteresis counter for an indirect branch that has been encountered by a front-end of the processor during a time period and retired; and
an indirect branch prediction logic to generate a prediction for an instruction corresponding to a indirect branch based on the stored bimodal hysteresis counter of the BTB.

2. The processor of claim 1, wherein an indirect branch hit is to cause allocation of an entry in the BTB as a weakly taken state, wherein the weakly taken state is to be modified to a strongly taken state in response to a hit of a same target by the indirect branch in the indirect branch prediction logic, and wherein the indirect branch prediction logic is to generate the prediction corresponding to the instruction corresponding to the indirect branch based on the state in the BTB.

3. The processor of claim 1, wherein an indirect branch hit is to cause allocation of an entry in the BTB with a state selected from a group comprising weakly taken state and strongly taken state, wherein the indirect branch prediction logic is to enter a lower power state in response to the state in the BTB.

4. The processor of claim 1, wherein a mispredicted indirect branch is to cause allocation of a corresponding entry into both the BTB and the indirect branch prediction logic.

5. The processor of claim 1, further comprising a bimodal prediction logic to generate a prediction for an instruction corresponding to a conditional or unconditional branch.

6. The processor of claim 1, wherein the front-end of the processor is to comprise one or more of: a fetch unit or a decode unit.

7. The processor of claim 1, further comprising a plurality of processor cores, wherein at least one of the plurality of processor cores is to comprise one or more of the BTB or the indirect branch prediction logic.

8. The processor of claim 1, further comprising a cache to store the instruction.

9. A method comprising:
storing a target address and a bimodal hysteresis counter for an indirect branch that has been encountered by a front-end of a processor during a time period and retired in a branch target buffer (BTB); and
generating a prediction corresponding to an instruction for a indirect branch based on the stored bimodal hysteresis counter of the BTB.

10. The method of claim 9, further comprising:
in response to hit by an indirect branch, allocating an entry in the BTB as a weakly taken state, wherein the weakly taken state is to be modified to a strongly taken state in response to a hit of a same target by the indirect branch in an indirect branch prediction logic; and
generating the prediction corresponding to the instruction corresponding to the indirect branch based on the state in the BTB.

11. The method of claim 9, further comprising:
in response to hit by an indirect branch, allocating an entry in the BTB with a state selected from a group comprising weakly taken state and strongly taken state; and
in response to the state in the BTB, causing an indirect branch prediction logic to enter a lower power state.

12. The method of claim 9, further comprising allocating a corresponding entry into both the BTB and an indirect branch prediction logic in response to mispredicting an indirect branch.

13. The method of claim 9, further comprising generating a bimodal prediction for an instruction corresponding to a conditional or unconditional branch.

14. The method of claim 9, further comprising storing the instruction in a cache.

15. A computing system comprising:
a memory to store an instruction corresponding to an indirect branch; and
a processor core comprising:
a branch target buffer (BTB) to store a target address and a bimodal hysteresis counter for an indirect branch that has been encountered by a front-end of the processor core during a time period and retired; and
an indirect branch prediction logic to generate a prediction for an instruction corresponding to a indirect branch based on the stored bimodal hysteresis counter of the BTB.

16. The system of claim 15, wherein an indirect branch hit is to cause allocation of an entry in the BTB as a weakly taken state, wherein the weakly taken state is to be modified to a strongly taken state in response to a hit of a same target by the indirect branch in the indirect branch prediction logic, and wherein the indirect branch prediction logic is to generate the prediction corresponding to the instruction corresponding to the indirect branch based on the state in the BTB.

17. The system of claim 15, wherein an indirect branch hit is to cause allocation of an entry in the BTB with a state selected from a group comprising weakly taken state and strongly taken state, wherein the indirect branch prediction logic is to enter a lower power state in response to the state in the BTB.

18. The system of claim 15, wherein a mispredicted indirect branch is to cause allocation of a corresponding entry into both the BTB and the indirect branch prediction logic.

19. The system of claim 15, wherein the front-end of the processor core is to comprise one or more of: a fetch unit or a decode unit.

20. The system of claim 15, further comprising an audio device coupled to the processor core.
